(19) United States
(12) Patent Application Publication
(10) Pub. No.: US 2025/0326279 A1
(43) Pub. Date: Oct. 23, 2025

(54) ANTI-DETACHMENT HOOD

(71) Applicant: Yi Lin, Ruian City (CN)

(72) Inventor: Yi Lin, Ruian City (CN)

(21) Appl. No.: 18/641,693

(22) Filed: Apr. 22, 2024

(51) Int. Cl. B60J 7/14

(52) U.S. Cl. CPC B60J 7/141

(57) ABSTRACT

The present invention discloses an anti-detachment hood comprising a plurality of plates, two adjacent plates are connected to each other by a shaft system, the shaft system comprising a first frame, a second frame and a rotation center, the first frame and the second frame are used to connect plate and are connected to each other by a rotation center, and the shaft system is connected to an anti-detachment structure.

### TECHNICAL FIELD

The present invention belongs to the field of automotive accessories and more particularly relates to an anti-detachment hood.

### TECHNICAL BACKGROUND

The cargo bin of a pickup truck (also known as a car-truck) is used to haul goods. Since the cargo bin of a pickup truck is open, in order to prevent the goods in the cargo bin from getting wet in rainy or snowy weather, people invented a truck cover that can be installed on the cargo bin of the pickup truck. The truck cover serves to shelter the goods in the cargo bin and prevent them from getting wet in the rain.

To facilitate the opening of the truck cover, a rotating shaft system is usually required. However, due to the frequent rotation of the rotating structure, this component is highly prone to damage. If the rotating shaft system breaks or is damaged due to bumps during vehicle travel, the truck cover may fall off the vehicle body, posing a significant risk.

### SUMMARY OF THE INVENTION

To address the issue of the easily damaged rotating structure of the existing truck cover, which can lead to the truck cover falling off, the present invention proposes an anti-detachment truck hood.

In order to solve the above problems existing in the prior art, the present invention adopts the following technical solution:

An anti-detachment hood, it comprises a plurality of plates, two adjacent plates are connected to each other by a shaft system, the shaft system comprises a first frame, a second frame and a rotation center, the first frame and the second frame are used to connect the plate, the first frame and the second frame are connected by a rotating center, and the shaft system is connected to an anti-detachment structure.

An anti-detachment hood, it comprises a plurality of plates, two adjacent plates are connected to each other by a shaft system comprising a first frame, a second frame and a rotation center, the first frame and the second frame are used to connect the plate, and the first frame, the second frame and the rotation center are all made of hard materials, the first frame and the second frame are rotatably connected to the rotation center, respectively, the shaft system is connected to an anti-detachment structure, and the two ends of the anti-detachment structure are respectively connected to the first frame and the second frame.

The plates are connected by a shaft system which is frequently rotated, resulting in the rotating parts becoming loose with long-term use. Thus, by adding an anti-detachment structure to the shaft system, the risk of the hood falling off due to damage to the shaft system can be avoided.

An anti-detachment hood, it comprises a plurality of plates, two adjacent plates are connected to each other by a shaft system comprising a first frame, a second frame, and a rotation center, the first frame and the second frame are used to connect the plate, the first frame, the second frame and the rotation center are all made of hard materials, the first frame and the second frame are rotatably connected to the rotation center, respectively, and the shaft system is connected to an anti-detachment structure, the anti-detachment structure is connected to the first frame or the second frame, the other end of the anti-detachment structure is connected to the rotation center.

Furthermore, the first frame is provided with a first installation port and a first rotating hook, and the second frame is provided with a second installation port and a second rotating hook. Both ends of the rotation center are provided with a rotation cavity and a central axis. The first rotating hook and the second rotating hook rotate within the two rotation cavities respectively. Both ends of the first rotating hook and the second rotating hook are provided with bent hooks that cooperate with the central axis. The rotating shaft system serves as a rotating component between the panel bodies. Both the first installation port and the second installation port are used to connect the panel bodies. The first frame and the second frame are rotatably connected to the rotation center, thus enabling the folding of the panel bodies.

An anti-detachment hood, it comprises a plurality of plates, two adjacent plates are connected to each other by a shaft system, the shaft system comprises a first frame, a second frame, and a rotation center, the first frame and the second frame are used to connect the plate, The first frame and the second frame are respectively connected to the rotation center and the rotation center made of soft materials, the shaft system is connected to an anti-detachment structure, and the two ends of the anti-detachment structure are respectively connected to the first frame and the second frame.

Furthermore, the first frame comprises a first mounting port and a first clamping part; The second frame comprises a second mounting port and a second clamping part; The rotation center comprises a connection part. The two ends of the connecting part are respectively connected with a clamping part; The two said clamping parts extend into the first clamping part and the second clamping part respectively, and the first clamping part and the second clamping part are used to clamp and fix the rotation center, respectively, since the rotation center in this embodiment is made of a soft material such as rubber, the anti-detachment structure cannot be connected to the rotation center, but can only be connected to the first frame and the second frame.

Furthermore, the first frame is further provided with a first seal plate and a first press handle, the first press handle being connected to the first clamping part; The second frame is further provided with a second seal plate and a second press handle, the second press handle being connected to the second clamping part, since the rotation center is made of a soft material, it has some elasticity, so when the first seal plate is inserted between the connection part and the snap-in part, the rotation center can clamp the seal plate, which results in a good waterproofing effect, and the first seal plate is bonded to the connection part by adhesive, the second seal plate is also bonded to the connection part by adhesive, such a way of bonding by adhesive based on the waterproofing structure can not only improve the waterproofing effect, but also ensure the joint strength, thereby prolonging the service life of the spindle system.

Furthermore, the first frame is equipped with a first installation port and a first connecting slot, while the second frame is equipped with a second installation port and a second connecting slot. Both ends of the rotation center are provided with connecting blocks that are slidably connected to either the first connecting slot or the second connecting slot. Here, the connecting blocks slide in from the ends of the first and second connecting slots and connect with them accordingly. The first frame and the second frame are respectively connected with limiting blocks that are located at both ends of the rotation center. These limiting blocks serve to restrict the movement of the rotation center. Since the connecting blocks are slidably connected to either the first or second connecting slot, limiting blocks are set at both ends of the rotation center to prevent random sliding and ensure stability. The two sides of the rotation center are respectively connected to the first frame and the second frame through hinges. The rotating shaft system serves as a rotating component between the panel bodies. Both the first installation port and the second installation port are used to connect the panel bodies. The first frame and the second frame are rotatably connected to the rotation center, thus enabling the folding of the panel bodies.

An anti-detachment hood, it comprises a plurality of plates, two adjacent plates are connected to each other by the shaft system, the shaft system comprising a first frame, a second frame and a rotation center, the first frame and the second frame are used to connect the plate, the first frame, the second frame and the rotation center are all made of hard materials, the first frame and the second frame and are each connected to the rotation center by a bending body, and the shaft system is connected to an anti-detachment structure, the anti-detachment structure has two ends connected to the first frame and the second frame, respectively.

An anti-detachment hood, it comprises a plurality of plates, two adjacent plates are connected to each other by the shaft system, the shaft system comprising a first frame, a second frame and a rotation center, the first frame and the second frame are used to connect the plate, the first frame, the second frame and the rotation center are all made of hard materials, and the first frame and the second frame are connected to the rotation center by a bending body, respectively, and the shaft system is connected to an anti-detachment structure, the anti-detachment structure is connected at one end to the first frame or the second frame and at the other end to the rotation center.

Furthermore, the anti-detachment structure is an elastic band, both ends of which are connected to the shaft system by means of screws.

The advantageous effect of the present invention is that by adding an anti-detachment structure to the shaft system, the present invention is capable of preventing the vehicle cover from falling due to damage to the shaft system.

### BRIEF DESCRIPTION OF THE DRAWINGS

FIG. 1 is the connection diagram of the present invention I;

FIG. 2 is a partial enlargement of part A of FIG. 1;

FIG. 3 is the connection diagram of the present invention II;

FIG. 4 is a partial enlargement of part B of FIG. 3;

FIG. 5 is the connection diagram of the present invention III;

FIG. 6 is a partial enlargement of part C of FIG. 5;

FIG. 7 is the connection diagram of the present invention IV;

FIG. 8 is the structure diagram of embodiment 4;

FIG. 9 is the structure diagram of embodiment 6;

FIG. 10 is the structure diagram of embodiment 7;

FIG. 11 is the structure diagram of embodiment 8.

In the Figures: 1—plate; 2—shaft system; 21—first frame; 211—first mounting port; 212—first swivel hook; 213—first clamping part; 214—first press handle; 215—first connection slot; 216—first seal plate; 22—rotation center; 221—rotation chamber; 222—snap part; 223—connection part; 224—stop block; 225—center axis; 226—hinge; 227—connection block; 228—bending body; 23—second frame; 231—second mounting port; 232—second swivel hook; 233—second clamping part; 234—second compression handle; 235—second connection slot; 236—second seal plate; and 3—anti-detachment structure.

### DETAILED DESCRIPTION OF THE INVENTION

The present invention will be further described below in connection with the accompanying drawings and the markings on the drawings.

For a clearer understanding of the above objects, features and advantages of the present invention, the present invention will be described in detail below in connection with the accompanying drawings and specific embodiments. It should be noted that the embodiments of the present application and the features of the embodiments may be combined without conflict.

The terms “first”, “second”, “third” and the like are used only to differentiate the descriptions and are not to be understood as indicating or implying relative importance.

It should also be noted that in the description of the present invention, unless otherwise expressly specified and limited, the terms “establish”, “install”, “linked”, “connected” are to be understood in a broad sense, such as a fixed connection, a removable connection or a connection in one piece; a mechanical connection or an electrical connection; a direct connection or an indirect connection through an intermediate medium; or a connection within two elements. Those skilled in the art will understand the specific meanings of the above terms in the present invention in particular cases.

Specific embodiments of the present invention are described in detail below in conjunction with the accompanying drawings. It should be understood that the specific embodiments described herein are for illustration and explanation of the present invention only and are not intended to limit the present invention.

### Embodiment 1

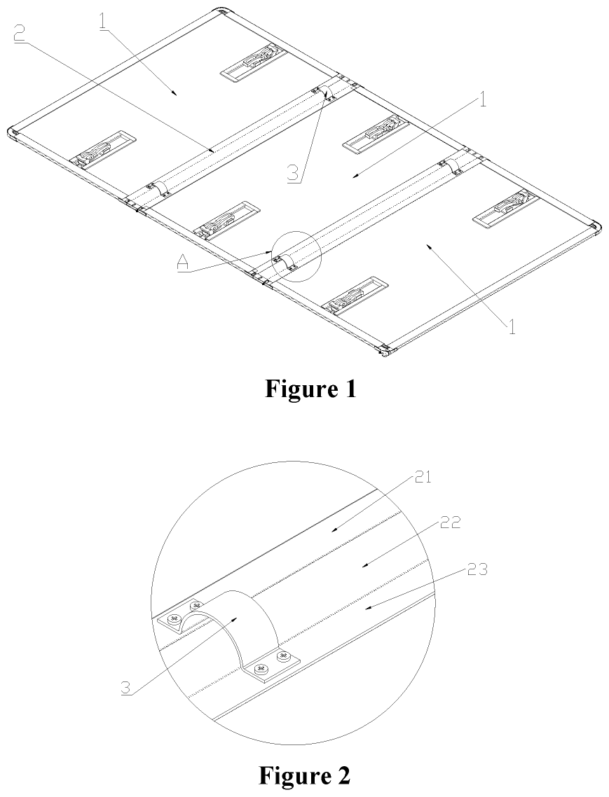

As shown in FIG. 1, an anti-detachment hood, it comprises a plurality of plates (1), two adjacent plates (1) are connected to each other by a shaft system (2), the shaft system (2) comprises a first frame (21), a second frame (23) and a rotation center (22), the first frame (21) and the second frame (23) are used to connect the plate (1), the first frame (21) and the second frame (23) are connected by a rotating center (22), and the shaft system (2) is connected to an anti-detachment structure (3).

### Embodiment 2

As shown in FIGS. 1 and 2, an anti-detachment hood, it comprises a plurality of plates (1), two adjacent plates (1) are connected to each other by a shaft system (2) comprising a first frame (21), a second frame (23) and a rotation center (22), the first frame (21) and the second frame (23) are used to connect the plate (1), and the first frame (21), the second frame (23) and the rotation center (22) are all made of hard materials, the first frame (21) and the second frame (23) are rotatably connected to the rotation center (22), respectively, the shaft system (2) is connected to an anti-detachment structure (3), and the two ends of the anti-detachment structure (3) are respectively connected to the first frame (21) and the second frame (23).

The plates (1) are connected by a shaft system (2) which is frequently rotated, the rotating part will become loose after long use, so adding an anti-detachment structure (3) to the shaft system (2) can prevent the risk of the hood falling off due to damage to the shaft system (2).

### Embodiment 3

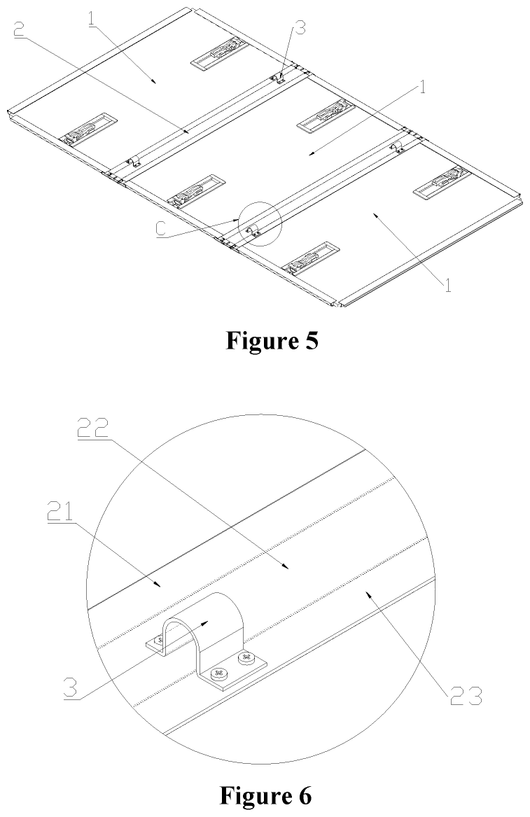

As shown in FIG. 5 and FIG. 6, an anti-detachment hood it comprises a plurality of plates (1), two adjacent plates (1) are connected to each other by a shaft system (2) comprising a first frame (21), a second frame (23), and a rotation center (22), the first frame (21) and the second frame (23) are used to connect the plate (1), the first frame (21), the second frame (23) and the rotation center (22) are all made of hard materials, the first frame (21) and the second frame (23) are rotatably connected to the rotation center (22), respectively, and the shaft system (2) is connected to an anti-detachment structure (3), the anti-detachment structure (3) is connected to the first frame (21) or the second frame (23), the other end of the anti-detachment structure (3) is connected to the rotation center (22).

### Embodiment 4

Based on embodiments 1-4, as shown in FIG. 8, the first frame (21) is provided with a first mounting port (211) and a first swivel hook (212);

The second frame (23) is provided with a second mounting port (231) and a second swivel hook (232);

The rotation center (22) is provided with a rotation chamber (221) and a center axis (225) at both ends, and the first swivel hook (212) and the second swivel hook (232) rotate in the two rotation chambers (221), respectively, the ends of the first swivel hook (212) and the second swivel hook (232) are all provided with curved hooks that fit into the center axis (225).

When the first frame (21) and the second frame (23) are rotated to be parallel to the rotation center (22), the first frame (21) and the second frame (23) are pressed against the rotation center (22), respectively, and at the same time the curved hooks are fitted with the center axis (225).

The shaft system (2) serves as a rotating component between the plate (1) and the plate (1). Both the first mounting port (211) and the second mounting port (231) are used to connect the plate (1), and the first frame (21) and the second frame (23) are rotatably connected to the rotation center (22), thereby allowing the plate (1) to be folded.

In practical installation, the two ends of the anti-detachment structure (3) may be connected to the first frame (21) and the second frame (23), or one end of the anti-detachment structure (3) may be connected to the rotation center (22), when the shaft system (2) is damaged, the anti-falling structure (3) can pull the plate (1) to provide protection.

### Embodiment 5

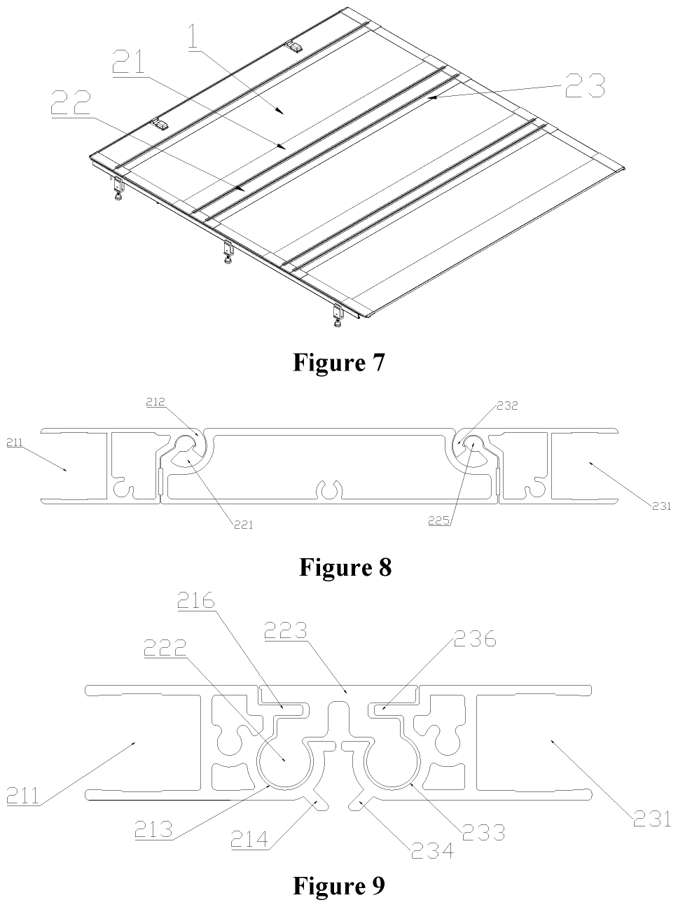

As shown in FIG. 1 and FIG. 7, an anti-detachment hood, characterized in that it comprises a plurality of plates (1), two adjacent plates (1) are connected to each other by a shaft system (2), the shaft system (2) comprises a first frame (21), a second frame (23), and a rotation center (22), the first frame (21) and the second frame (23) are used to connect the plate (1) The first frame (21) and the second frame (23) are respectively connected to the rotation center (22) and the rotation center (22) made of soft materials, the shaft system (2) is connected to an anti-detachment structure (3), and the two ends of the anti-detachment structure (3) are respectively connected to the first frame (21) and the second frame (23).

### Embodiment 6

Based on embodiment 5, as shown in FIG. 9, the first frame (21) comprises a first mounting port (211) and a first clamping part (213);

The second frame (23) comprises a second mounting port (231) and a second clamping part (233);

The rotation center (22) comprises a connection part (223) The two ends of the connecting part (223) are respectively connected with a clamping part (222);

The two said clamping parts (222) extend into the first clamping part (213) and the second clamping part (233) respectively, and the first clamping part (213) and the second clamping part (233) are used to clamp and fix the rotation center (22), respectively.

Since the rotation center (22) in this embodiment is made of soft materials such as rubber, the anti-detachment structure (3) cannot be connected to the rotation center (22), but can only be connected to the first frame (21) and the second frame (23).

The anti-detachment hood according to claim 6, characterized in that: the first frame (21) is further provided with a first seal plate (216) and a first press handle (214), the first press handle (214) being connected to the first clamping part (213);

The second frame (23) is further provided with a second seal plate (236) and a second press handle (234), the second press handle (234) being connected to the second clamping part (233);

Since the rotation center (22) is made of a soft material with a certain degree of elasticity, when the sealing plate is inserted between the connecting part (223) and the engaging part (222), the rotation center (22) can clamp the sealing plate tightly, achieving excellent waterproof performance.

The first sealing plate (216) is bonded to the connecting part (223) with glue, and the second sealing plate (236) is also bonded to the connecting part (223) with glue.

Based on the waterproof structure, the adhesive is used for bonding, which not only improves the waterproofing effect, but also ensures the strength of the joint, thereby prolonging the service life of the shaft system (2).

### Embodiment 7

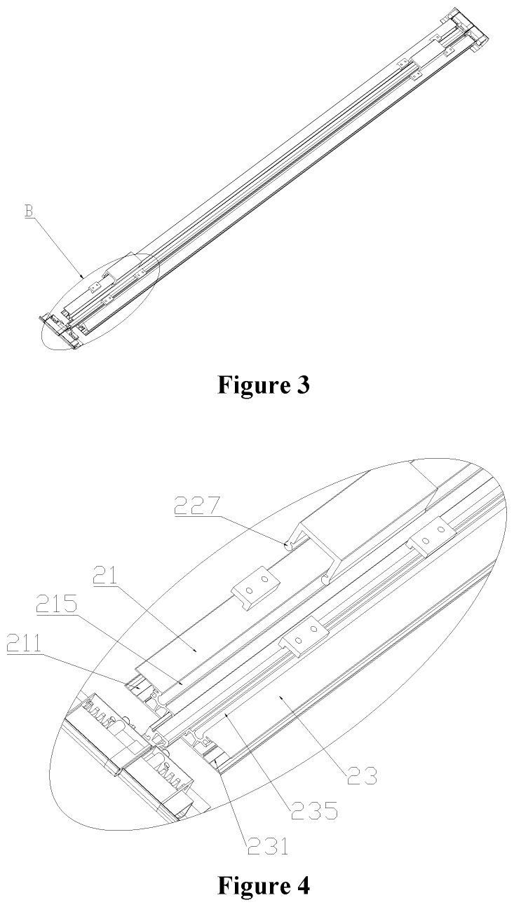

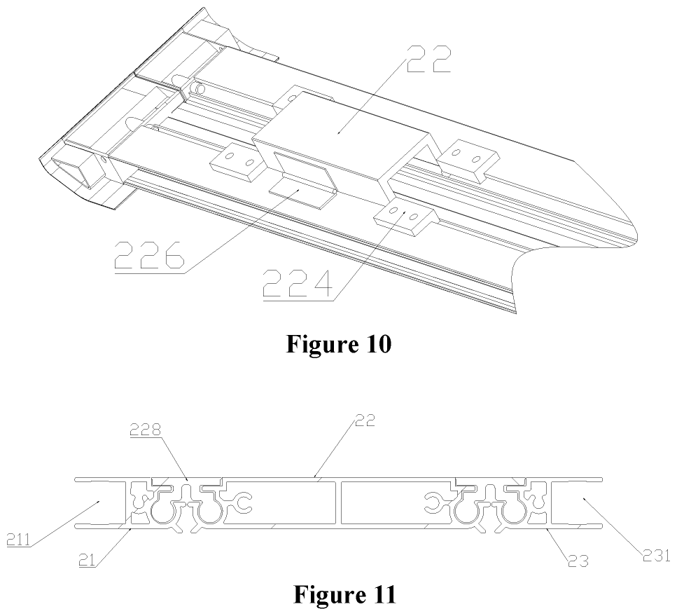

As shown in FIGS. 3, 4 and 10, an anti-detachment hood, characterized in that: it comprises a plurality of plates (1), two adjacent plates (1) are connected to each other by a shaft system (2), the shaft system (2) comprises a first frame (21), a second frame (23), and a rotation center (22); The first frame (21) and the second frame (23) are used to connect the plate (1), both the first frame (21) and the second frame (23) are made of hard material, the first frame (21) is provided with a first connection slot (215).

The second frame (23) is provided with the second mounting port (231) and the second connection slot (235).

The rotation center (22) is provided with connection blocks (227) at both ends, and the connection blocks (227) are slidably connected to the first connection slot (215) or the second connection slot (235) (Here, “or” refers to the connecting block (227) on the same side being connected to either the first connecting slot (215) or the second connecting slot (235), while the connecting blocks (227) on both sides are connected to the first connecting slot (215) and the second connecting slot (235) respectively). The shaft system (2) is connected to an anti-detachment structure (3), the two ends of the anti-detachment structure (3) are respectively connected to the first frame (21) and the second frame (23). The connecting blocks (227) slide into the ends of the first connecting slot (215) and the second connecting slot (235), and are connected to either the first connecting slot (215) or the second connecting slot (235).

The first frame (21) and the second frame (23) are respectively connected to stop blocks (224), the stop blocks (224) are set at both ends of the rotation center (22), and the stop blocks (224) are used to limit the rotation center (22).

Since the connection blocks (227) are slidably connected to the first connection slot (215) or the second connection slot (235), to prevent it from sliding freely, at both ends of the rotation center (22), set limit block (224) to limit the rotation center and prevent it from sliding.

The two sides of the rotation center are connected to the first frame (21) and to the second frame (23), respectively, by means of hinges (226).

The shaft system (2) serves as a rotating component between the plate (1) and the plate (1), the first mounting port (211) and the second mounting port (231) are both used to connect the plate (1), and the first frame (21) and the second frame (23) are rotatably connected to the rotation center (22), thereby making the plates foldable.

In practical installation, the two ends of the anti-detachment structure (3) can be connected to the first frame (21) and the second frame (23), or one end of the anti-detachment structure (3) can be connected to the rotation center (22), so that when the shaft system (2) is broken, the anti-detachment structure (3) can play a protective role to pull the plate (1). After connection, the hinge structure can allow the plates (1) to rotate with each other, and the hinge structure also has the advantage of being convenient to perform disassembly and replacement.

However, the hinge structure is also unable to connect the anti-detachment structure (3), so that the anti-detachment structure (3) an still only be connected to the first frame (21) and the second frame (23).

### Embodiment 8

As shown in FIGS. 1-4 and 11, an anti-detachment hood, it comprises a plurality of plates (1), two adjacent plates (1) are connected to each other by the shaft system (2), the shaft system (2) comprising a first frame (21), a second frame (23) and a rotation center (22), the first frame (21) and the second frame (23) are used to connect the plate (1), the first frame (21), the second frame (23) and the rotation center (22) are all made of hard materials, the first frame (21) and the second frame (23) and are each connected to the rotation center (22) by a bending body (228), and the shaft system (2) is connected to an anti-detachment structure (3), the anti-detachment structure (3) has two ends connected to the first frame (21) and the second frame (23), respectively, the bending body (228) is made of flexible material, and the first frame (21), the second frame (23) and the rotation center (22) are connected to the bending body (228) by fixed clamping.

### Embodiment 9

As shown in FIGS. 1-4 and 11, an anti-detachment hood, it comprises a plurality of plates (1), two adjacent plates (1) are connected to each other by the shaft system (2), the shaft system (2) comprising a first frame (21), a second frame (23) and a rotation center (22), the first frame (21) and the second frame (23) are used to connect the plate (1), the first frame (21), the second frame (23) and the rotation center (22) are all made of hard materials, and the first frame (21) and the second frame (23) are connected to the rotation center (22) by a bending body (228), respectively, and the shaft system (2) is connected to an anti-detachment structure (3), the anti-detachment structure (3) is connected at one end to the first frame (21) or the second frame (23) and at the other end to the rotation center (22).

### Embodiment 10

Based on embodiments 1-9, the anti-detachment structure (3) is an elastic band, both ends of which are connected to the shaft system (2) by means of screws.

The present invention is not limited to the above optional embodiments and any person may make various other forms of products under the inspiration of the present invention, but regardless of any changes in shape or structure thereof, any technical solution falling within the defined scope of the claims of the present invention falls within the scope of protection of the present invention.

1. An anti-detachment hood, characterized in that it comprises a plurality of plates (1), two adjacent plates (1) are connected to each other by a shaft system (2), the shaft system (2) comprises a first frame (21), a second frame (23) and a rotation center (22), the first frame (21) and the second frame (23) are used to connect the plate (1), the first frame (21) and the second frame (23) are connected by a rotating center (22), and the shaft system (2) is connected to an anti-detachment structure (3).

2. An anti-detachment hood, characterized in that it comprises a plurality of plates (1), two adjacent plates (1) are connected to each other by a shaft system (2) comprising a first frame (21), a second frame (23) and a rotation center (22), the first frame (21) and the second frame (23) are used to connect the plate (1), and the first frame (21), the second frame (23) and the rotation center (22) are all made of hard materials, the first frame (21) and the second frame (23) are rotatably connected to the rotation center (22), respectively, the shaft system (2) is connected to an anti-detachment structure (3), and the two ends of the anti-detachment structure (3) are respectively connected to the first frame (21) and the second frame (23).

3. An anti-detachment hood characterized in that it comprises a plurality of plates (1), two adjacent plates (1) are connected to each other by a shaft system (2) comprising a first frame (21), a second frame (23), and a rotation center (22), the first frame (21) and the second frame (23) are used to connect the plate (1), the first frame (21), the second frame (23) and the rotation center (22) are all made of hard materials, the first frame (21) and the second frame (23) are rotatably connected to the rotation center (22), respectively, and the shaft system (2) is connected to an anti-detachment structure (3), the anti-detachment structure (3) is connected to the first frame (21) or the second frame (23), the other end of the anti-detachment structure (3) is connected to the rotation center (22).

4. The anti-detachment hood according to claim 2 or 3, characterized in that: the first frame (21) is provided with a first mounting port (211) and a first swivel hook (212);
The second frame (23) is provided with a second mounting port (231) and a second swivel hook (232);
The rotation center (22) is provided with a rotation chamber (221) and a center axis (225) at both ends, and the first swivel hook (212) and the second swivel hook (232) rotate in the two rotation chambers (221), respectively.

5. An anti-detachment hood, characterized in that it comprises a plurality of plates (1), two adjacent plates (1) are connected to each other by a shaft system (2), the shaft system (2) comprises a first frame (21), a second frame (23), and a rotation center (22), the first frame (21) and the second frame (23) are used to connect the plate (1) The first frame (21) and the second frame (23) are respectively connected to the rotation center (22) and the rotation center (22) made of soft materials, the shaft system (2) is connected to an anti-detachment structure (3), and the two ends of the anti-detachment structure (3) are respectively connected to the first frame (21) and the second frame (23).

6. The anti-detachment hood according to claim 5, characterized in that: the first frame (21) comprises a first mounting port (211) and a first clamping part (213);
The second frame (23) comprises a second mounting port (231) and a second clamping part (233);
The rotation center (22) comprises a connection part (223) The two ends of the connecting part (223) are respectively connected with a clamping part (222);
The two said clamping parts (222) extend into the first clamping part (213) and the second clamping part (233) respectively, and the first clamping part (213) and the second clamping part (233) are used to clamp and fix the rotation center (22), respectively.

7. The anti-detachment hood according to claim 6, characterized in that: the first frame (21) is further provided with a first seal plate (216) and a first press handle (214), the first press handle (214) being connected to the first clamping part (213);
The second frame (23) is further provided with a second seal plate (236) and a second press handle (234), the second press handle (234) being connected to the second clamping part (233).

8. An anti-detachment hood, characterized in that: it comprises a plurality of plates (1), two adjacent plates (1) are connected to each other by a shaft system (2), the shaft system (2) comprises a first frame (21), a second frame (23), and a rotation center (22);
The first frame (21) and the second frame (23) are used to connect the plate (1), both the first frame (21) and the second frame (23) are made of hard material, the first frame (21) is provided with a first connection slot (215), while the second frame (23) is provided with a second connection slot (235);
The rotation center (22) is provided with connection blocks (227) at both ends, and the connection blocks (227) are slidably connected to the first connection slot (215) or the second connection slot (235);
The shaft system (2) is connected to an anti-detachment structure (3), the two ends of the anti-detachment structure (3) are respectively connected to the first frame (21) and the second frame (23).

9. The anti-detachment hood according to claim 8, characterized in that: the first frame (21) and the second frame (23) are respectively connected to stop blocks (224), the stop blocks (224) are set at both ends of the rotation center (22), and the stop blocks (224) are used to limit the rotation center (22).

10. The anti-detachment hood according to claim 8, characterized in that: the two sides of the rotation center are connected to the first frame (21) and to the second frame (23), respectively, by means of hinges (226).

11. An anti-detachment hood, characterized in that it comprises a plurality of plates (1), two adjacent plates (1) are connected to each other by the shaft system (2), the shaft system (2) comprising a first frame (21), a second frame (23) and a rotation center (22), the first frame (21) and the second frame (23) are used to connect the plate (1), the first frame (21), the second frame (23) and the rotation center (22) are all made of hard materials, the first frame (21) and the second frame (23) and are each connected to the rotation center (22) by a bending body (228), and the shaft system (2) is connected to an anti-detachment structure (3), the anti-detachment structure (3) has two ends connected to the first frame (21) and the second frame (23), respectively.

12. An anti-detachment hood, characterized in that it comprises a plurality of plates (1), two adjacent plates (1) are connected to each other by the shaft system (2), the shaft system (2) comprising a first frame (21), a second frame (23) and a rotation center (22), the first frame (21) and the second frame (23) are used to connect the plate (1), the first frame (21), the second frame (23) and the rotation center (22) are all made of hard materials, and the first frame (21) and the second frame (23) are connected to the rotation center (22) by a bending body (228), respectively, and the shaft system (2) is connected to an anti-detachment structure (3), the anti-detachment structure (3) is connected at one end to the first frame (21) or the second frame (23) and at the other end to the rotation center (22).

13. The anti-detachment hood according to claim 11 or 12, characterized in that: the bending body (228) is made of flexible material, and the first frame (21), the second frame (23) and the rotation center (22) are connected to the bending body (228) by fixed clamping.

14. The anti-detachment hood according to any one of claims 1, 2, 3, 5, 8, 11, 12, characterized in that: the anti-detachment structure (3) is an elastic band, both ends of which are connected to the shaft system (2) by means of screws.
